(19) United States
(12) Patent Application Publication
(10) Pub. No.: US 2025/0350064 A1
(43) Pub. Date: Nov. 13, 2025

(54) MALE PLUG MECHANISM, FEMALE SOCKET MECHANISM AND CIRCULAR CONNECTOR USING SAME

(71) Applicant: PALCONN TECHNOLOGY CO., LTD, Shenzhen (CN)

(72) Inventors: Liangjun Luo, Shenzhen (CN); Zelin Sun, Shenzhen (CN)

(21) Appl. No.: 18/749,650

(22) Filed: Jun. 21, 2024

(30) Foreign Application Priority Data
May 10, 2024 (CN) 202421001141.0

(51) Int. Cl. H01R 13/508; H01R 13/622

(52) U.S. Cl. CPC H01R 13/508; H01R 13/622

(57) ABSTRACT

The present invention discloses a male plug mechanism, a female socket mechanism and a circular connector using same. In the present invention, the male plug shell assembly is arranged to protect the male plug terminal assembly and prevent damage to the male plug terminal assembly, and the outer shell is connected with an outer side of the inner shell through the clamping member to prevent circumferential deviation of the outer shell relative to the inner shell, so that the male plug mechanism is easy to align with the female socket mechanism during use, and the outer shell will not be moved axially in vibration and other environments, having a good stability of connection with the inner shell and the female socket mechanism.

### CROSS REFERENCE TO RELATED APPLICATIONS

The present application claims the benefit of Chinese Patent Application No. 202421001141.0 filed on May 10, 2024, the contents of which are incorporated herein by reference in their entirety.

### FIELD OF INVENTION

The present invention belongs to the technical field of connectors, and particularly relates to a male plug mechanism, a female socket mechanism and a circular connector using same.

### BACKGROUND ART OF THE INVENTION

A circular connector is a connector with a cylindrical basic structure and a circular insertion surface, and a circular structure has a higher strength than any other shape. Circular connectors are originated in military equipment manufacturing industry in the last century, and are gradually extended to civilian field to provide connection and transmission of power, signals and data for various equipment and systems. At present, circular connectors are widely used in the fields such as arms industry, aviation, medical care and industry.

Relative displacement is easy to occur between an inner shell and an outer shell of a male plug mechanism in an existing circular connector, resulting in difficult alignment when the male plug mechanism is connected with a female socket mechanism, and the male plug mechanism is easy to detach from the female socket mechanism when used in vibration and other environments for a long time, resulting in interrupted connection and transmission of power, signals and data.

### DISCLOSURE OF THE INVENTION

In view of this, the purpose of the present invention is to provide a male plug mechanism, which solves the problems that relative displacement is easy to occur between an inner shell and an outer shell of a male plug mechanism in an existing circular connector, resulting in difficult alignment when the male plug mechanism is connected with a female socket mechanism, and the male plug mechanism is easy to detach from the female socket mechanism when used in vibration and other environments for a long time, resulting in interrupted connection and transmission of power, signals and data.

The purpose of the present invention is also to provide a female socket mechanism matched with the male plug mechanism.

The purpose of the present invention is also to provide a circular connector using the male plug mechanism and the female socket mechanism.

To achieve the above purpose, a first technical solution of the present invention is realized as follows: a male plug mechanism, comprising a male plug shell assembly and a male plug terminal assembly arranged in the male plug shell assembly, wherein the male plug shell assembly comprises a clamping member, an inner shell and an outer shell sheathed on the inner shell, and the clamping member is arranged between the outer shell and the inner shell and used for limiting the outer shell.

Further, the clamping member is ring-shaped, the clamping member is sheathed on the inner shell, spring leaves are arranged circumferentially on one side of the clamping member close to the outer shell, and the spring leaves are butted with an inner wall of the outer shell.

Further, at least two spring leaves are used, and the at least two spring leaves are arranged circumferentially on one side of the outer shell.

Further, the male plug terminal assembly comprises a first male plug insulator, a second male plug insulator and a male plug terminal, wherein the first male plug insulator and the second male plug insulator are arranged in the inner shell, and the male plug terminal is threaded into the first male plug insulator and the second male plug insulator.

Further, an inner wall of the inner shell is provided with a positioning stage, one end of the inner shell is provided with a wire clamping assembly, outer walls of one side of the first male plug insulator and one side of the second male plug insulator close to each other are provided with a first positioning bulge, respectively, and the two first positioning bulges are stuck between the positioning stage and the wire clamping assembly.

A second technical solution of the present invention is realized as follows: a female socket mechanism, comprising a female socket shell and a female socket terminal assembly arranged in the female socket shell, wherein the female socket terminal assembly comprises a first female socket insulator, a second female socket insulator and a female socket terminal, the first female socket insulator and the second female socket insulator are arranged in the female socket shell, and the female socket terminal is threaded into the first female socket insulator and the second female socket insulator.

Further, an inner wall of the female socket shell is provided with a clamping ring and a positioning lug boss, outer walls of one side of the first female socket insulator and one side of the second female socket insulator close to each other are provided with a second positioning bulge, respectively, and the two second positioning bulges are stuck between the clamping ring and the positioning lug boss.

A third technical solution of the present invention is realized as follows: a circular connector, comprising the male plug mechanism, the female socket mechanism, and a quick lock assembly, wherein the male plug shell assembly in the male plug mechanism is matched and connected with the female socket shell in the female socket mechanism through the quick lock assembly.

Further, the female socket shell is provided with clamping slots, the male plug shell assembly is provided with clamping parts matched the clamping slots, and the clamping slots and the clamping parts constitute the quick lock assembly.

Further, the positioning lug boss is arranged in the female socket shell on one end close to the male plug mechanism, and when the clamping parts are matched and connected with the clamping slots, the end of the inner shell is pressed against the positioning lug boss.

Further, an outer wall of the inner shell is provided with a plurality of positioning slots extending axially along the inner shell, the inner wall of the outer shell is provided with a plurality of positioning parts matched with the positioning slots, one end of each positioning part extends out of the outer shell, and the end is provided with a clamping part.

Compared with the prior art, the present invention has the following beneficial effects: in the male plug mechanism, the male plug shell assembly is arranged to protect the male plug terminal assembly and prevent damage to the male plug terminal assembly, and the outer shell is connected with an outer side of the inner shell through the clamping member to prevent circumferential deviation of the outer shell relative to the inner shell, so that the male plug mechanism is easy to align with the female socket mechanism during use, and the outer shell will not be moved axially in vibration and other environments, having a good stability of connection with the inner shell and the female socket mechanism.

### DESCRIPTION OF THE DRAWINGS

FIG. 1 is an integral schematic diagram of a male plug mechanism provided by the present invention;

FIG. 2 is an exploded view of a male plug mechanism provided by the present invention;

FIG. 3 is an integral schematic diagram of a female socket mechanism provided by the present invention;

FIG. 4 is an exploded view of a female socket mechanism provided by the present invention;

FIG. 5 is an integral schematic diagram of a circular connector provided by the present invention;

FIG. 6 is a sectional view of a circular connector provided by the present invention.

In the figures, 1—male plug mechanism, 11—male plug shell assembly, 111—inner shell, 1111—positioning stage, 1112—positioning slot, 112—clamping member, 1121—spring leaf, 113—outer shell, 1131—positioning part, 12—male plug terminal assembly, 121—first male plug insulator, 1211—first positioning bulge, 122—second male plug insulator, 123—male plug terminal;
2—female socket mechanism, 21—female socket shell, 22—female socket terminal assembly, 221—first female socket insulator, 2211—second positioning bulge, 222—second female socket insulator, 223—female socket terminal, 23—clamping ring, 24—positioning lug boss;
3—quick lock assembly, 31—clamping slot, 32—clamping part.

### DETAILED DESCRIPTION OF THE INVENTION

To make the purpose, the technical solution and the advantages of the present invention more clear, the present invention will be further described below in detail in combination with the embodiments. It should be understood that the specific embodiments described herein are only used for explaining the present invention, not used for limiting the present invention.

It should be clear in the description of the present invention that terms such as “perpendicular”, “transverse”, “longitudinal”, “front”, “rear”, “left”, “right”, “upper”, “lower”, “horizontal”, etc. indicate direction or position relationships shown based on the drawings, and are only intended to facilitate the description of the present invention rather than to mean that the indicated device or element must have a specific direction or position, and therefore, shall not be understood as a limitation to the present invention. It should be noted in the description of the present invention that, unless otherwise specifically regulated and defined, terms such as “installation,” “connected,” and “connecting” shall be understood in broad sense, and for example, may refer to fixed connection or detachable connection or integral connection, and may refer to direct connection or indirect connection through an intermediate medium. For those ordinary skilled in the art, the meanings of the above terms in the present invention may be understood according to concrete conditions.

### Embodiment 1

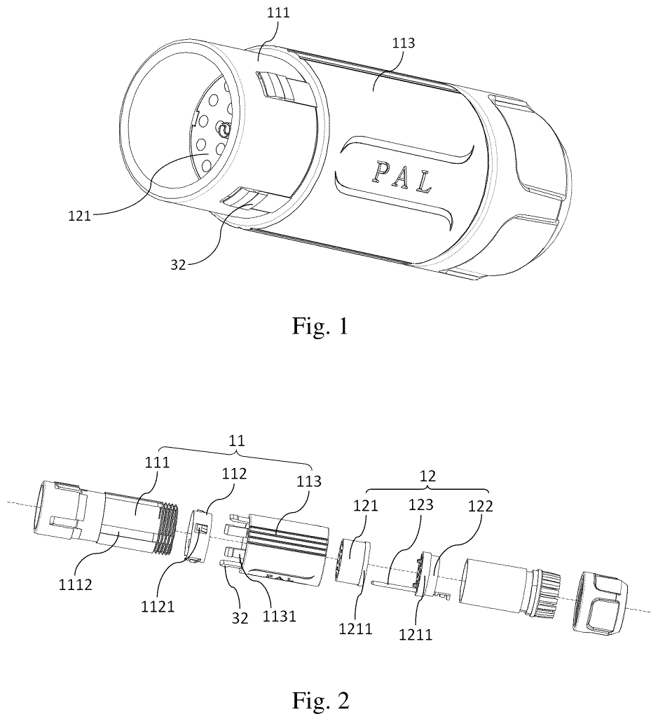

As shown in FIG. 1 and FIG. 2, a male plug mechanism provided by the embodiment comprises a male plug shell assembly 11 and a male plug terminal assembly 12 arranged in the male plug shell assembly 11, wherein the male plug shell assembly 11 comprises a clamping member 112, an inner shell 111 and an outer shell 113 sheathed on the inner shell 111, and the clamping member 112 is arranged between the outer shell 113 and the inner shell 111 and used for limiting the outer shell 113.

In the male plug mechanism, the male plug shell assembly 11 is arranged to protect the male plug terminal assembly 12 and prevent damage to the male plug terminal assembly 12, the inner shell 111 provides an installation space for the outer shell 113 and the male plug terminal assembly 12, and the outer shell 113 is connected with an outer side of the inner shell 111 through the clamping member 112 to prevent circumferential deviation of the outer shell 113 relative to the inner shell 111, so that the male plug mechanism 1 is easy to align with the female socket mechanism 2 during use, and the outer shell 113 will not be moved axially in vibration and other environments, having a good stability of connection with the inner shell 111 and the female socket mechanism 2.

In some embodiments of the present application, the clamping member 112 is ring-shaped, the clamping member 112 is sheathed on the inner shell 111, spring leaves 1121 are arranged circumferentially on one side of the clamping member 112 close to the outer shell 113, and the spring leaves 1121 are butted with an inner wall of the outer shell 113.

In some embodiments of the present application, at least two spring leaves 1121 are used, and the at least two spring leaves 1121 are arranged circumferentially on one side of the outer shell 113.

When the embodiment is used, the clamping member 112 is sheathed on the outer side of the inner shell 111, one side of each of a plurality of spring leaves 1121 is fixed to the clamping member 112, and the other end has a certain gap with a surface of the clamping slot 112 and can be bounced around a junction with the clamping slot 112; when the outer shell 113 is sheathed on the inner shell 111, the spring leaves 1121 extend outwards and are butted with the inner wall of the outer shell 113 to limit the outer shell 113 and prevent axial movement and circumferential deviation of the outer shell 113 relative to the inner shell 111.

In some embodiments of the present application, the male plug terminal assembly 12 comprises a first male plug insulator 121, a second male plug insulator 122 and a male plug terminal 123, wherein the first male plug insulator 121 and the second male plug insulator 122 are arranged in the inner shell 111, and the male plug terminal 123 is threaded into the first male plug insulator 121 and the second male plug insulator 122.

When the male plug mechanism 1 is used, one end thereof is connected with the female socket mechanism 2, and the other end is connected with a structure such as a cable; with the arrangement of the first male plug insulator 121 and the second male plug insulator 122, insulation performance at both ends of the male plug mechanism 1 can be adjusted flexibly to meet using requirements of different equipment and systems.

With the arrangement of the first male plug insulator 121 and the second male plug insulator 122, one or more male plug terminals 123 can be arranged at desired positions and spacing and will not tilt during use, thereby preventing current leakage and crosstalk among the multiple male plug terminals 123 and between the male plug terminals 123 and the male plug shell assembly 11, and ensuring transmission quality of power, signals and data.

In some embodiments of the present application, an inner wall of the inner shell 111 is provided with a positioning stage 1111, one end of the inner shell 111 is provided with a wire clamping assembly, outer walls of one side of the first male plug insulator 121 and one side of the second male plug insulator 122 close to each other are provided with a first positioning bulge 1211, respectively, and the two first positioning bulges 1211 are stuck between the positioning stage 1111 and the wire clamping assembly.

In the embodiment, the inner wall of the inner shell 111 is concave away from an axis of the inner shell 111 to form the positioning stage 1111, one side of the first positioning bulge 1211 on the outer wall of the first male plug insulator 121 is butted with the positioning stage 1111, the other side is butted with one side of the first positioning bulge 1211 on the outer wall of the second male plug insulator 122, and the other side of the first positioning bulge 1211 on the outer wall of second male plug insulator 122 is butted with the wire clamping assembly; axial positions of the first male plug insulator 121 and the second male plug insulator 122 are limited by the positioning stage 1111, thus to limit the male plug terminal 123 threaded into the first male plug insulator 121 and the second male plug insulator 122, prevent the male plug terminal 123 from detaching from the female socket mechanism 2 when used in vibration and other working environments, and ensure that the connection between the male plug mechanism 1 and the female socket mechanism 2 is stable.

Specifically, the wire clamping assembly comprises a wire clamp and a nut, one end of the wire clamp extends into the inner shell 111 and is butted with the first positioning bulge 1211 on the outer wall of the second male plug insulator 122, the other end of the wire clamp is circumferentially provided with a plurality of clamping pieces which can retract towards the axis of the inner shell 111, one end and an outer edge of each clamping piece are connected with the nut, and the nut is also in threaded connection with the outer side of the inner shell 111; when used, the nut is in threaded connection with the inner shell 111, and in this process, the ends of the clamping pieces are pushed by the nut to retract towards the axis of the inner shell 111, thus to clamp a cable threaded therein, prevent the cable from being detached from the male plug terminal 123 under an external force, and ensure transmission stability of power, signals and data.

The male plug mechanism 1 is also provided with a protective ring which is specifically arranged between the inner shell 111 and the wire clamp to prevent vapor, dust, etc. from entering the circular connector from the end with the cable and ensure using effect of the circular connector.

### Embodiment 2

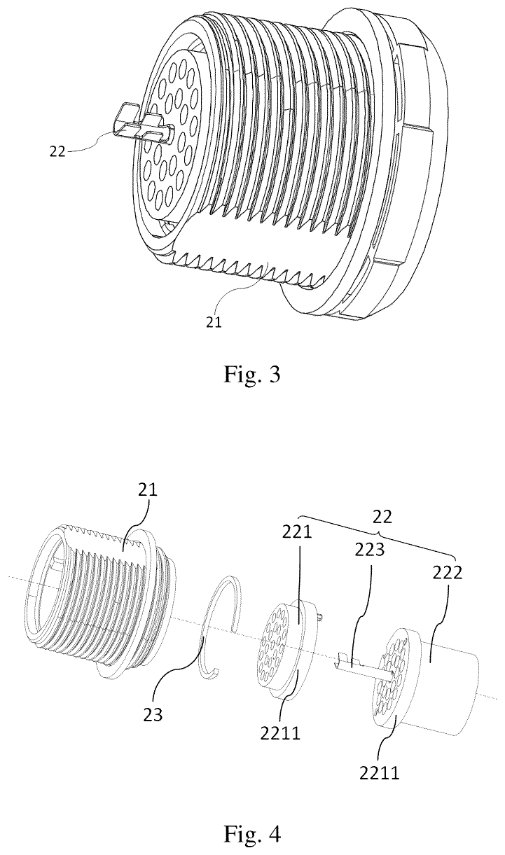

As shown in FIG. 3 and FIG. 4, a female socket mechanism provided by the embodiment comprises a female socket shell 21 and a female socket terminal assembly 22 arranged in the female socket shell 21, and the female socket terminal assembly 12 comprises a first female socket insulator 221, a second female socket insulator 222 and a female socket terminal 223, wherein the first female socket insulator 221 and the second female socket insulator 222 are arranged in the female socket shell 21, and the female socket terminal 223 is threaded into the first female socket insulator 221 and the second female socket insulator 222.

In the embodiment, the female socket shell 21 provides an installation space for the first female socket insulator 221, the second female socket insulator 222 and the female socket terminal 223 to prevent internal parts of the female socket mechanism 2 from being damaged; the female socket shell 21 is connected with the female socket terminal 223 through the first female socket insulator 221 and the second female socket insulator 222; when one or more female socket terminals 223 are used, the female socket terminals 223 can be arranged at desired positions and spacing by the first female socket insulator 221 and the second female socket insulator 222 and will not tilt during use, thereby ensuring connection stability between the female socket terminals 223 and the male plug terminals 123 in the male plug mechanism 1, making the multiple female socket terminals 223 have gaps with each other, preventing current leakage and crosstalk among the multiple female socket terminals 223 and between the female socket terminals 223 and the female socket shell 21, and ensuring transmission quality of power, signals and data.

With the arrangement of the first female socket insulator 221 and the second female socket insulator 222, insulation performance at both ends of the female socket mechanism 2 can be adjusted conveniently to meet using requirements of different equipment and systems.

In some embodiments of the present application, an inner wall of the female socket shell 21 is provided with a clamping ring 23 and a positioning lug boss 24, outer walls of one side of the first female socket insulator 221 and one side of the second female socket insulator 222 close to each other are provided with a second positioning bulge 2211, respectively, and the two second positioning bulges 2211 are stuck between the clamping ring 23 and the positioning lug boss 24.

In the embodiment, axial positions of the first female socket insulator 221 and the second female socket insulator 222 are limited by the clamping ring 23 and the positioning lug boss 24, thus to prevent axial movement of the first female socket insulator 221 and the second female socket insulator 222 relative to the female socket shell 21 in vibration and other using environments, enable the female socket terminal 223 threaded into the first female socket insulator 221 and the second female socket insulator 222 to be connected stably with the male plug terminal 123, and ensure transmission stability of power, signals and data.

In some embodiments of the present application, the female socket shell 21 is provided with external threads on an outer side and is in threaded connection with two nuts for the convenience of installing the female socket shell 21 on an equipment housing.

The female socket mechanism 2 is also provided with an inner protective ring and an outer protective ring, the inner protective ring and the outer protective ring are arranged between the two nuts, and when the female socket shell 21 is threaded into the equipment housing, the outer protective ring is butted with the equipment housing; the inner protective ring is arranged on an inner side of the female socket shell 21, when the male plug mechanism 1 is connected with the female socket shell 21, the outer side of the inner shell 111 is butted with the inner protective ring to prevent vapor, dust, etc. from entering and ensure using effect of the circular connector.

### Embodiment 3

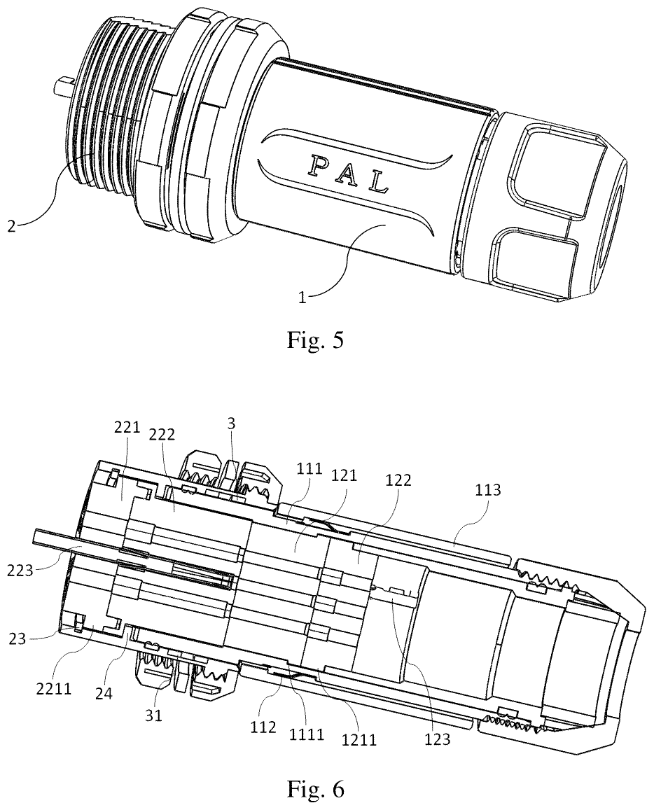

As shown in FIG. 5, a circular connector provided by the embodiment comprises the male plug mechanism 1 of embodiment 1, the female socket mechanism 2 of embodiment 2, and a quick lock assembly 3, wherein the male plug shell assembly 11 in the male plug mechanism 1 is matched and connected with the female socket shell 21 in the female socket mechanism 2 through the quick lock assembly 3.

When the circular connector is used, the female socket terminal 223 and the male plug terminal 123 are coupled to realize connection and transmission of power, signals and data in various equipment and systems, and the female socket shell 21 is connected with the male plug shell assembly 11 through the quick lock assembly 3 to ensure secure connection between the female socket terminal 223 and the male plug terminal 123, prevent transmission interruption caused by detachment of the female socket terminal 223 from the male plug terminal 123 in vibration and other working environments, ensure transmission stability of power, signals and data, and be convenient to disassemble and assemble.

As shown in FIG. 6, in some embodiments of the present application, the female socket shell 21 is provided with clamping slots 31, the male plug shell assembly 11 is provided with clamping parts 32 matched the clamping slots 31, and the clamping slots 31 and the clamping parts 32 constitute the quick lock assembly 3.

In the embodiment, the clamping parts 32 are withdrawn from or stuck in the clamping slots 31 to realize quick disassembly and assembly of the female socket shell 21 and the male plug shell assembly 11, prevent the male plug terminal 123 and the female socket terminal 223 from detachment in vibration and other using environments, and improve connection stability between the male plug mechanism 1 and the female socket mechanism 2 as well as transmission quality of power, signals and data.

In some embodiments of the present application, the positioning lug boss 24 is arranged in the female socket shell 21 on one end close to the male plug mechanism 1, and when the clamping parts 32 are matched and connected with the clamping slots 31, the end of the inner shell 111 is pressed against the positioning lug boss 24.

In the embodiment, depth of the inner shell 111 extending into the female socket shell 21 is limited by the positioning lug boss 24 to ensure that the clamping parts 32 can be accurately stuck in the clamping slots 31 by a user in case of blind insertion, and improve assembly and disassembly efficiency of the male plug mechanism 1 and the female socket mechanism 2.

In some embodiments of the present application, an outer wall of the inner shell 111 is provided with a plurality of positioning slots 1112 extending axially along the inner shell 111, the inner wall of the outer shell 113 is provided with a plurality of positioning parts 1131 matched with the positioning slots 1112, one end of each positioning part 1131 extends out of the outer shell 1113, and the end is provided with a clamping part 32.

In the embodiment, the positioning slots 1112 and the positioning parts 1131 are arranged to circumferentially limit the outer shell 113 and the inner shell 111, and prevent rotation of the inner shell 111 relative to the outer shell 113.

In some embodiments of the present application, the inner wall of the female socket shell 21 is provided with a guide groove, and the outer wall of the inner shell 111 is provided with a guide block matched with the guide groove, or the inner wall of the female socket shell 21 is provided with a guide block, and the outer wall of the inner shell 111 is provided with a guide groove matched with the guide block; with the arrangement of the guide groove and the guide block, coupling efficiency of the male plug mechanism 1 and the female socket mechanism 2 can be improved, and poor transmission quality caused by inaccurate coupling of male plug terminal 123 and the female socket terminal 223 in case of blind insertion can be avoided.

In some embodiments of the present application, the female socket terminal 223 and the male plug terminal 123 have solid cylinder structures made by turning or hollow cylinder structures made by stamping and curling; preferably, the female socket terminal 223 and the male plug terminal 123 have hollow cylinder structures made by stamping and curling.

At present, the female socket terminal 223 and the male plug terminal 123 are often prepared into cylindrical shapes by a turning process, and in this process, cost of equipment required is high, and preparation time is long; during assembly, it is necessary to manually insert the female socket terminal 223 into the female socket shell 21 and insert the male plug terminal 123 into the male plug shell assembly 11, so the assembly requires a high cost and a long time; however, if mechanical assembly is adopted, surfaces of the female socket terminal 223 and the male plug terminal 123 will be scratched by a mechanical arm when clamping the female socket terminal 223 and the male plug terminal 123, causing unnecessary losses.

In the embodiment, expanded parts of the female socket terminal 223 and the male plug terminal 123 are made on a plate by the stamping process, and the expanded parts are made into hollow cylinder shaped female socket terminal 223 and male plug terminal 123 by a curling process, which can save consumables and has simple preparation processes, low cost and short time. As the female socket terminal 223 and the male plug terminal 123 prepared are connected by the plate, during assembly, a junction on the plate is clamped and the plate is rotated to put the female socket terminal 223 into the first female socket insulator 221 and the second female socket insulator 222 in turn, put the male plug terminal 123 into the first male plug insulator 121 and the second male plug insulator 122 in turn, and cut apart the female socket terminal 223 and the male plug terminal 123 connected by the plate; the process can be operated mechanically without causing any loss, which increases assembly efficiency and reduces losses.

A method for using the circular connector provided by the embodiment is specifically as follows:

When used, the female socket shell 21 in the female socket mechanism 2 is threaded through the equipment housing, nuts are in threaded connection with the female socket shell 21 on both sides of the equipment housing to fix the female socket shell 21 to the equipment housing, the male plug shell assembly 11 in the male plug mechanism is connected with the female socket shell 21, the end of the inner shell 111 is butted with the positioning lug boss 24 on the inner side of the female socket shell 21, the clamping parts 32 on the outer shell 113 are stuck in the clamping slots 31 on the inner side of the female socket shell 21, and the female socket terminal 223 and the male plug terminal 123 are coupled to realize connection and transmission of power, signals and data; in this process, the clamping slots 31 and the clamping parts 32 are easy to disassemble and assemble and can ensure connection stability between the female socket mechanism 2 and the male plug mechanism 1, thus to prevent the female socket mechanism 2 and the male plug mechanism 1 from detachment in vibration and other using environments, and ensure connection and transmission effects.

The above only describes preferred specific embodiments of the present invention, but the protection scope of the present invention is not limited thereto. Any change or replacement contemplated easily by those skilled in the art familiar with the technical field within the technical scope disclosed by the present invention shall be covered within the protection scope of the present invention. Therefore, the protection scope of the present invention should be determined by the protection scope of the claims.

What is claimed:

1. A male plug mechanism, comprising a male plug shell assembly (11) and a male plug terminal assembly (12) arranged in the male plug shell assembly (11), and characterized in that the male plug shell assembly (11) comprises a clamping member (112), an inner shell (111) and an outer shell (113) sheathed on the inner shell (111), and the clamping member (112) is arranged between the outer shell (113) and the inner shell (111) and used for limiting the outer shell (113).

2. The male plug mechanism as claimed in claim 1, characterized in that the clamping member (112) is ring-shaped, the clamping member (112) is sheathed on the inner shell (111), spring leaves (1121) are arranged circumferentially on one side of the clamping member (112) close to the outer shell (113), and the spring leaves (1121) are butted with an inner wall of the outer shell (113).

3. The male plug mechanism as claimed in claim 2, characterized in that at least two spring leaves (1121) are used, and the at least two spring leaves (1121) are arranged circumferentially on one side of the outer shell (113).

4. The male plug mechanism as claimed in claim 1, characterized in that the male plug terminal assembly (12) comprises a first male plug insulator (121), a second male plug insulator (122) and a male plug terminal (123), wherein the first male plug insulator (121) and the second male plug insulator (122) are arranged in the inner shell (111), and the male plug terminal (123) is threaded into the first male plug insulator (121) and the second male plug insulator (122).

5. The male plug mechanism as claimed in claim 4, characterized in that an inner wall of the inner shell (111) is provided with a positioning stage (1111), one end of the inner shell (111) is provided with a wire clamping assembly, outer walls of one side of the first male plug insulator (121) and one side of the second male plug insulator (122) close to each other are provided with a first positioning bulge (1211), respectively, and the two first positioning bulges (1211) are stuck between the positioning stage (1111) and the wire clamping assembly.

6. A female socket mechanism, comprising a female socket shell (21) and a female socket terminal assembly (22) arranged in the female socket shell (21), and characterized in that the female socket terminal assembly (12) comprises a first female socket insulator (221), a second female socket insulator (222) and a female socket terminal (223), wherein the first female socket insulator (221) and the second female socket insulator (222) are arranged in the female socket shell (21), and the female socket terminal (223) is threaded into the first female socket insulator (221) and the second female socket insulator (222).

7. The female socket mechanism as claimed in claim 6, characterized in that an inner wall of the female socket shell (21) is provided with a clamping ring (23) and a positioning lug boss (24), outer walls of one side of the first female socket insulator (221) and one side of the second female socket insulator (222) close to each other are provided with a second positioning bulge (2211), respectively, and the two second positioning bulges (2211) are stuck between the clamping ring (23) and the positioning lug boss (24).

8. A circular connector, characterized in comprising the male plug mechanism (1) as claimed in claim 1, a female socket mechanism (2) comprising a female socket shell (21) and a female socket terminal assembly (22) arranged in the female socket shell (21), and characterized in that the female socket terminal assembly (12) comprises a first female socket insulator (221), a second female socket insulator (222) and a female socket terminal (223), wherein the first female socket insulator (221) and the second female socket insulator (222) are arranged in the female socket shell (21), and the female socket terminal (223) is threaded into the first female socket insulator (221) and the second female socket insulator (222),
and comprising a quick lock assembly (3), wherein the male plug shell assembly (11) in the male plug mechanism (1) is matched and connected with the female socket shell (21) in the female socket mechanism (2) through the quick lock assembly (3).

9. The circular connector as claimed in claim 8, characterized in that the female socket shell (21) is provided with clamping slots (31), the male plug shell assembly (11) is provided with clamping parts (32) matched the clamping slots (31), and the clamping slots (31) and the clamping parts (32) constitute the quick lock assembly (3).

10. The circular connector as claimed in claim 9, characterized in that the positioning lug boss (24) is arranged in the female socket shell (21) on one end close to the male plug mechanism (1), and when the clamping parts (32) are matched and connected with the clamping slots (31), the end of the inner shell (111) is pressed against the positioning lug boss (24).

11. The circular connector as claimed in claim 8, characterized in that the clamping member (112) is ring-shaped, the clamping member (112) is sheathed on the inner shell (111), spring leaves (1121) are arranged circumferentially on one side of the clamping member (112) close to the outer shell (113), and the spring leaves (1121) are butted with an inner wall of the outer shell (113).

12. The circular connector as claimed in claim 11, characterized in that the female socket shell (21) is provided with clamping slots (31), the male plug shell assembly (11) is provided with clamping parts (32) matched the clamping slots (31), and the clamping slots (31) and the clamping parts (32) constitute the quick lock assembly (3).

13. The circular connector as claimed in claim 12, characterized in that the positioning lug boss (24) is arranged in the female socket shell (21) on one end close to the male plug mechanism (1), and when the clamping parts (32) are matched and connected with the clamping slots (31), the end of the inner shell (111) is pressed against the positioning lug boss (24).

14. The circular connector as claimed in claim 11, characterized in that at least two spring leaves (1121) are used, and the at least two spring leaves (1121) are arranged circumferentially on one side of the outer shell (113).

15. The circular connector as claimed in claim 14, characterized in that the female socket shell (21) is provided with clamping slots (31), the male plug shell assembly (11) is provided with clamping parts (32) matched the clamping slots (31), and the clamping slots (31) and the clamping parts (32) constitute the quick lock assembly (3).

16. The circular connector as claimed in claim 15, characterized in that the positioning lug boss (24) is arranged in the female socket shell (21) on one end close to the male plug mechanism (1), and when the clamping parts (32) are matched and connected with the clamping slots (31), the end of the inner shell (111) is pressed against the positioning lug boss (24).

17. The circular connector as claimed in claim 8, characterized in that the male plug terminal assembly (12) comprises a first male plug insulator (121), a second male plug insulator (122) and a male plug terminal (123), wherein the first male plug insulator (121) and the second male plug insulator (122) are arranged in the inner shell (111), and the male plug terminal (123) is threaded into the first male plug insulator (121) and the second male plug insulator (122).

18. The circular connector as claimed in claim 17, characterized in that an inner wall of the inner shell (111) is provided with a positioning stage (1111), one end of the inner shell (111) is provided with a wire clamping assembly, outer walls of one side of the first male plug insulator (121) and one side of the second male plug insulator (122) close to each other are provided with a first positioning bulge (1211), respectively, and the two first positioning bulges (1211) are stuck between the positioning stage (1111) and the wire clamping assembly.

19. The circular connector as claimed in claim 18, characterized in that the female socket shell (21) is provided with clamping slots (31), the male plug shell assembly (11) is provided with clamping parts (32) matched the clamping slots (31), and the clamping slots (31) and the clamping parts (32) constitute the quick lock assembly (3).

20. The circular connector as claimed in claim 19, characterized in that the positioning lug boss (24) is arranged in the female socket shell (21) on one end close to the male plug mechanism (1), and when the clamping parts (32) are matched and connected with the clamping slots (31), the end of the inner shell (111) is pressed against the positioning lug boss (24).
